(19) United States
(12) Patent Application Publication
(10) Pub. No.: US 2014/0365582 A1
(43) Pub. Date: Dec. 11, 2014

(54) Information Management System And Method

(71) Applicant: Dynmark International Ltd, Cheltenham (GB)

(72) Inventors: David Baddeley, Cheltenham (GB); Paul Putman, Cheltenham (GB)

(21) Appl. No.: 13/910,286

(22) Filed: Jun. 5, 2013

(51) Int. Cl. H04L 12/58

(52) U.S. Cl. CPC H04L 51/04
USPC 709/206

(57) ABSTRACT

An information management system comprising an activity database to receive messaging data from multiple user equipment devices over at least one messaging channel of a network, a profile engine to generate a profile for an identity using the messaging data, the identity associated with at least one of the devices.

### TECHNICAL FIELD

The present invention generally relates to wireless devices and communications networks. In particular the invention relates to processing and interpretation of behavioural, contextual and optionally technical data associated with messaging in wireless devices.

### BACKGROUND

In a telecommunication network or system, messaging service components can be used to allow messages to be exchanged between devices that are part of or otherwise using the network. Such messaging services include for example SMS (short messaging service) and MMS (multimedia messaging service)—the former enabling the transfer of text-based messages between devices, the latter providing a somewhat richer experience inasmuch as messages including multimedia content, such as images, can be exchanged.

Recently, options for message-based communications have further increased with the provision of a number of low-cost and free alternatives to the above-noted services that provide a somewhat richer user experience. The alternatives are typically referred to as over-the-top (OTT) services, as they enable devices to exchange messages without recourse to the traditional methods of delivery associated with standard messaging services—that is, they operate ‘over-the-top’ of the telecommunication network and operate using a provider-independent platform. An OTT application will typically be provided by way of application (app) on a user device or as a service that enables communication over the Internet or using a telecommunication data plan or connection associated with the device, and which therefore bypasses traditional distribution of such content. Broadly speaking, there are currently two different OTT alternatives that have emerged: operating system (OS) specific systems and third-party applications, which are typically cross-platform. Both sets of applications enable a richer user experience, but at a reduced (or zero) price compared with traditional messaging services.

Typically, a user of a mobile device, such as a mobile telephone for example, will send and receive multiple messages over the course of a given period of time, such as a day for example, using any one or more of the above-noted methods.

### SUMMARY OF THE INVENTION

According to an aspect, there is provided an information management system comprising an activity database to receive messaging data from multiple user equipment devices over at least one messaging channel of a network, a profile engine to generate a profile for an identity using the messaging data, the identity associated with at least one of the devices.

A messaging channel can be an SMS channel of a telecommunication network and/or a messaging channel of an over-the-top peer-to-peer communication network. The identity is globally unique identity for the network. The identity can be an internationalised format phone number. The profile engine can be operable to generate a profile for an identity including multiple dimensions relating to network activity. The activity database can be operable to receive messaging data representing a message to be forwarded over or that is received from the network, process the messaging data to determine message content, and parse the content to determine the presence of a URL.

According to an aspect, there is provided a computer program product, comprising a computer usable medium having computer readable program code embodied therein, said computer readable program code adapted to be executed to implement a method for generating data relating to multiple recipients of a message by receiving messaging data from multiple user equipment devices over at least one messaging channel of a network at an activity database, generating a profile for an identity using the messaging data at a profile engine, the identity associated with at least one of the devices.

According to an aspect, there is provided a computer-implemented method to generate data relating to multiple recipients of a message, comprising monitoring the behaviour of a recipient of the message to determine multiple measures associated with receipt and consumption of the message and message content by the recipient at a device, processing data representing the characteristics to provide profile data for a recipient, providing a set of filters to form a query template for filtering the profile data to generate data for a recipient relating to multiple behavioural and factual characteristics. The method can further include determining the presence of one or more URLs in the message, shortening or otherwise processing the URL to provide a modified link to data associated with the URL, providing a correlation ID to directly correlate a click through event for the modified link, using data associated with the event to determine one or more behavioural characteristics of the recipient. A behavioural characteristic can represent a receipient's propensity to respond to or open the message, or follow the link after receipt of the message.

### BRIEF DESCRIPTION OF THE DRAWINGS

Embodiments will now be described, by way of example only, with reference to the accompanying drawings, in which:

FIG. 1 is a schematic block diagram of a system according to an example;

FIG. 2 is a flowchart of data for an activity database according to an example; and

FIG. 3 is a schematic block diagram of a system according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

According to an example, a phone number intelligence database and a profile engine can be used to collect and analyse data relating to phone numbers, and more particularly messages that are sent between devices, such as to and from a pair of devices, or to a device from an enterprise sending a marketing or informative communication for example. In addition, click through analysis can be performed in which URLs that may be embedded in or otherwise provided for a message that has been received have been followed ('clicked'). Certain characteristics associated with the analysis can be used to determine a user's propensity to respond to or open such messages, such as the time taken to follow a link (URL) after receipt for example. In this connection, a URL for a message can be shortened and can include a trackable element that enables a click through event to be captured.

Advanced reporting and analysis can be performed and made available. Areas that can be analysed and reported on include:
Market Sector Analysis
Device Information
Mobile Networks
Click Through Behaviour
Message rate and volumes targeted at the phone number
Message rate and volume sent by the phone number
Messaging and Click Through Activity by the hour of the day
Speed of Response to Messaging and Click Through's
Type of responses grouped by:
   Positive
   Opt Out
   Expletive

All of the above areas are tracked over:
Time
Delivery Channel Type (i.e. SMS, OTT etc . . . )

Any and all of these areas can be analysed in different combinations to answer a myriad of queries such as:
What days of the week do you get the best response rates?
What market sectors have the best response rates?
What country has the best response rates for betting market sector?
Do you get fewer stops if you message in the afternoon or the evening?
What is the most popular device?
What percentage of phones have web capabilities?
When is the best time to send a message to get a favourable response?

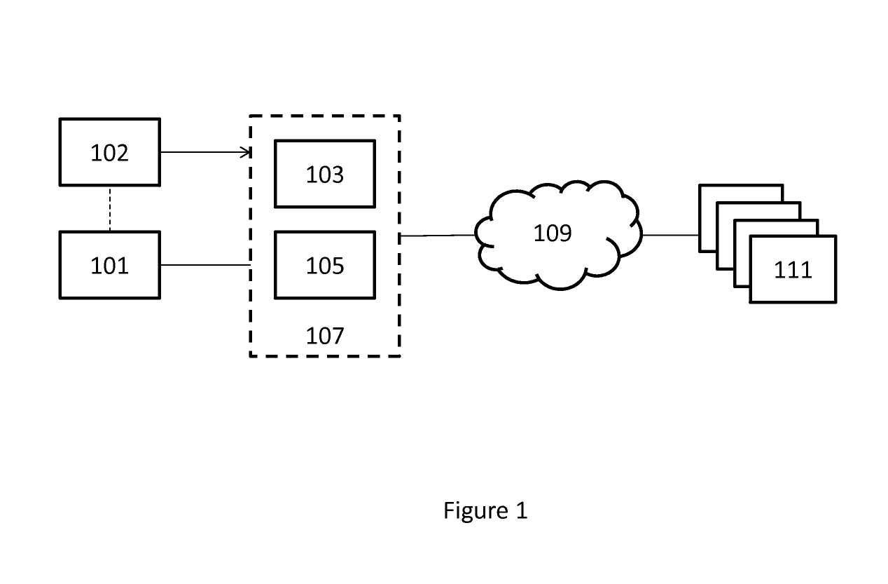

FIG. 1 is a schematic block diagram of a system according to an example. A user equipment device 101 is capable of sending and receiving data representing messages over a network 109. The network 109 is capable of supporting multiple user equipment devices 111, one or more of which can receive a message from device via system 107 and network 109, and which can send a message to device 101 via network 109 and system 107. In an example, network 109 is a telecommunication network, such as a 3G network for example, capable of supporting voice and data transmission between multiple devices. A device 101 can be referred to as a device, terminal, mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various embodiments of the device can include a cellular phone, a smart phone having a wireless communication function, a personal digital assistant (PDA) having a wireless communication function, a wireless modem, a portable computer having a wireless communication function, a capturing device such as a digital camera having wireless communication function, a game device having a wireless communication function, a music storage and replay appliance having a wireless communication function, an Internet appliance enabling wireless Internet access and browsing, and terminals or a portable unit having combinations of the functions. Other alternatives are possible.

In an alternative example, device 101 can send and receive data via the internet if it has the appropriate connection. Similarly, a receiving device can receive message data via a cellular network or over the internet as will be appreciated.

An activity database 103 is provided as part of the system 107 to receive messaging and click through data 102 from user equipment device 101, or from multiple such devices as will typically be the case, over at least one messaging channel of a network. A messaging channel can include a channel for delivery or receipt of an SMS or MMS message using the network 109, and can also include a channel in which a message is sent or received using an over-the-top (OTT) service over network 109 for example, or alternatively, using a data plan of a device over network 109. For example, an OTT service can be used in which a message is sent or received using TCP/IP with data representing the message being sent over network 109, such as the internet if the device 101 is connected thereto, or being sent using a data plan of the device 101 using network 109.

A profile engine 105 is used to generate a profile for an identity using the messaging data 102. The identity can be associated with multiple devices. In an example, the identity is linked to a device. However, as users use multiple devices and can migrate a phone number for example from one mobile device to another, the identity is a globally unique identifier that can be, for example, a phone number associated with the device, an IMSI, or any other such identifier for example. Each identifier, and thus each ultimate device, is typically therefore linked to an ultimate recipient, whatever device they may be using. In an example, as a recipient is identified according to the identifier or identity, the routing of a message is thus largely device independent. That is, a unique identifier can be migrated from device to device, such as when a user ports their number to a new phone for example. Accordingly, in an example, an identifier or identity can be a device independent identifier that more broadly defines a sender or recipient for a message, rather than identifying a specific device for a message. As such references herein to a ‘number’ should be taken to include reference to an identifier, which can include an identifier as described above.

In an example, activity database 103 and profile engine 105 can be implemented in a computer system including a processor, memory, non-volatile storage, and an interface for example. Peripheral devices can also be provided as part of the computer system. A typical computer system will include at least a processor, memory, and a device (e.g., a bus) coupling the memory to the processor. The processor can include, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

A processor is considered to be “configured to execute a program” when at least one value associated with the program is stored in a register readable by the processor. The bus can also couple the processor to one or more interfaces. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In an example, database 103 is primarily keyed against an internationalised format phone number with no pluses or formatting characters e.g. 447715178605 or 441242651300, and which provides the identity for which a profile can be generated by engine 105. Factual data associated with a phone number, can include a time stamp, such as a UTC time stamp when the record was initially created in the database; the country that the phone is registered in, which can be held in 3 character ISO country code format for example; the last active timestamp, which can be the UTC time stamp recorded when the phone number was last active on a network. When setting this, a ‘considered dead timestamp’ indicating that the number is considered dead, i.e. not registered on a network can be cleared, as this is no longer the case as the number is active.

A last used premium services timestamp can be provided, and is a UTC time stamp indicating when the phone number last used a premium service. A null value can indicate that the number has never used a premium service. In an example, this metric can be used to assess whether the phone number user has ever used premium messaging service and therefore would likely do so again.

A last used shortcode timestamp can be provided to indicate when the phone number last sent a message to a shortcode. A null value can indicate that the number has never sent a message to a shortcode. This metric can be used to assess whether the phone number user has ever responded to an advert using a shortcode for example.

A last out of credit time stamp can be used to indicate when the phone was last reported to have no credit; this is useful for determining the affluence of the phone number's user for example.

Extended information can be provided in database 103, and can be held in a name/value pair list associated with the phone number to allow extensibility over time for other facts about the phone number that are not already covered, such as 3rd party information. The format of the extended value can be included to allow comparisons to be made and can include:
a) Text
b) Number
c) Timestamp

In an example, extended properties may alter over time and their history can be tracked. Location information can be tracked over time with an entry being recorded for each time the phone numbers current location is determined. This information can be used to determine the likelihood of travel and whether the phone is likely within the country at the time of sending for example.

Database 103 can include other data relating to phone number totals for example such as:

Total Outbound Messages, indicating the running total of messages ever sent to this phone number via any network.

Total Inbound Messages indicating the running total of messages ever received from this phone number via any network.

Response Percentage, indicating the percentage chance of a phone number responding to a message in total, and over all data captured ever.

Total Stop Messages, indicating the running total of “stop” messages received from this phone via any network. A message is considered a stop message when:
a) The first word is “stop”
b) The first word is a recognised keyword and the second word is “stop”

Stop Response Percentage, indicating the percentage chance of a phone number responding to a message with a “stop” message in total, and over all data captured ever.

Total Expletive Messages, indicating the running total of messages that contained an expletive; this is important as frustrated phone users often use expletives rather than the proper stop keywords to try and opt out. Causing a high degree of expletive responses would indicate a poorly conceived or targeted messaging campaign for example. The system can include an extensible list of expletives in order to allow accurate detection.

An expletive Response Percentage, indicating the percentage chance of a phone number responding to a message with an expletive in the message in total, and over all data captured ever.

Total Click-Throughs, indicating the running total of shortened URL click-throughs the user has used as a result of tracking, which is discussed below.

Total URLs Sent, indicating the running total of URLs sent to the user that have been sent to a user within a message. Click-Through Percentage, indicating the percentage chance of a phone number using a click-through link within a message in total, and over all data captured ever.

In addition, network data fields or dimensions can be provided, such as:

Original Network, indicating the phone network the phone was registered on originally. Current Network, indicating the phone network the phone is registered on currently. ‘Is Ported’, indicating whether the phone number has been ported over networks or not. In an example, the number is considered ported if the Original Network and Current Network do not match. IMSI, indicating the International Mobile Subscriber Identity, which is the unique subscriber number given to the SIM.

In addition, device specific data fields or dimensions can be provided, such as:

IMEI, indicating the International Mobile Equipment Identity, which allows the handset type to be recognised. Device Description, providing an English human readable description of the phone device the phone number is associated with. Operating System, indicating the operating system of the device, including the version when available. ‘Is Web Enabled Device’, which can be a Boolean flag to indicate whether the device is capable of web browsing. ‘Is CDMA’, indicating if the device uses CDMA networks instead of GSM for example.

In addition, lookup data fields or dimensions can be provided, which are static lists of information, such as:

Mobile Network, in which the mobile network name and country will be held;
Operating System, indicating operating system family and OS full version name;

### Market Sector;

Behavioural Data associated with a phone number which is gathered by analysing the messaging activity around this phone number.

According to an example, behavioural data associated with an identity will, unlike factual data, be subject to potential frequent changes as the person who uses the phone number or device changes their attitude towards market sectors or mobile messaging in general. For example, a phone number may have responded well to betting sector messages for 3 years but in the last month stopped responding.

To ensure that recent behaviour can be analysed behavioural statistics are retained as follows:
Daily with a lifespan of 6 weeks
Weekly with a lifespan of 12 months
Monthly with a lifespan of 10 years.

Using this data, behavioural trends can be determined for yearly, half yearly, quarterly, monthly and weekly, as well as overall behaviour. Overall behaviour will also become more significant when recent data is sparse.

The approximate business sector that a message is related to can be determined by using the users account business sector information. This sector information can be used in order to track the behavioural metrics by business sector for a phone number for example. This can add value to the data stored by profiling in more detail a number's interests for example.

An outbound message event can be used to determine the outbound messaging characteristics for a phone number. Outbound messaging facts relating to outbound messaging for a phone number can be tracked. In an example, a correlation ID can be provided to correlate any responses to an outbound message where a delivery channel supports them.

Outbound messaging facts can be dimensioned by the following notions in order to allow complex behaviour to be determined about a phone number. Any combination of the dimensions can be used to determine the expected behaviour of a phone number user towards those dimensions. To determine an overall behavioural profile the dimensions in the query would simply be ignored. For example, to determine how many messages have been sent to a phone number in the last month for the Betting & Trading market sector the query would combine the Phone Number, Week in Year and Market Sector dimensions.

In an example, database 103 can be provided with data indicating the delivery channel that messages are being communicated over for a device/phone number/identity, such as for example SMS, MMS, other OTT channels or mechanisms, and so on, and an inbound messenger event can be provided to determine the behavioural characteristic of a phone number regards responses to outbound messages. Using a combination of data from the outbound behavioural metrics and the inbound behavioural metrics the user of the phone number's propensity to send stop messages, send expletive messages or positively respond can therefore be determined.

Inbound messaging data can be tracked using a correlation ID, which is a unique identifier to directly correlate a response to an outbound event. In addition, inbound messaging data can be tracked if it is a stop or opt out message, or if it contains expletives for example.

The inbound messaging facts can be dimensioned by the following notions to allow complex behaviour to be determined about a phone number. Any combination of the dimensions can be used to determine the expected behaviour of a phone number user towards those dimensions. To determine an overall behavioural profile for example, the dimensions in the query can be ignored. That is, for example, to determine which users send stop messages within an hour of a marketing message being sent to them in the last 6 months the query would use the Week in Year and Response Times dimensions to identify the phone numbers that match this profile. Inbound messaging data dimension can include:

Phone Number—The Phone Number the facts are related to.
Market Sector—The market sector used to differentiate what business sectors direct marketing campaign accounts for example are associated with so that behaviour towards certain market sectors to be ascertained.
Created Time—This will allow a view of inbound behaviour to be determined for up to the last rolling year, or any shorter period such as last 6 months, last month and so on. This dimension therefore gives the flexibility to determine if behaviour is changing over the last year.
UTC Hour—this will allow the response behaviour to be analysed to determine what hours of the day the phone number is more receptive to messages, therefore allowing more effective targeting.
Response Times—It is important to be able to understand how fast responses are received to outbound messages. To reduce data volumes and make this easier to summarise, the time it took from submitting a message to a carrier until the response was received can thus be categorised to within a predefined timeframe.
Delivery Channel—This indicates the delivery channel the messages are being communicated over, such as SMS, MMS, other OTT systems for example. Other delivery channels can include those associated with OTT delivery mechanisms for example, in addition to more conventional delivery channels.

According to an example, data can be generated to track how many URLs are embedded in messages. This data used in conjunction with Click-Through Behavioural Metrics to determine a percentage propensity to use click-throughs within messages for example.

The following data for Embedded URLs in messaging for a phone number can be tracked:
a) Correlation Id—Unique id used to directly correlate the embedded URL to the click through event

For a click-through event associated with a user selecting an embedded URL in a message, the captured data relating to the click through can be used to determine the behavioural characteristics of a phone number with regards to using click through URLs within messages, and a correlation ID to directly correlate the click through event to the URL embedding event can be provided. Similarly to above, this can be dimensioned by multiple fields to allow complex behaviour to be determined about a phone number. Any combination of the dimensions can be used to determine the expected behaviour of a phone number user towards those dimensions. To determine an overall behavioural profile you would simply ignore the dimensions in the query. For example:

Phone Number—The Phone Number the facts are related to.
Market Sector—The market sector used to differentiate what business sectors the DMC accounts are associated with to allow behaviour towards certain market sectors to be ascertained.
Created Time—This will allow a view of click-through behaviour to be determined for up to the last rolling year, or any shorter period such as last 6 months, last month and so on. This dimension therefore gives the flexibility to determine if behaviour is changing over the last year.
UTC Hour—This will allow the response behaviour to be analysed to determine what hours of the day the phone number is more receptive to messages, therefore allowing more effective targeting.
Response Times—It is important to be able to understand how fast phone number users utilise a click-through to determine the propensity to respond to embedded URLs. To reduce data volumes and make this easier to summarise the time it took from submitting the message to the carrier until the click-through was clicked can be categorised within predefined time ranges, such as up to 10 minutes for example.

According to an example, data and thus intelligence about a number is extracted at every possible opportunity within a framework for processing of messages and phone number related services. For example, with reference to FIG. 1, system 107 provides a gateway between devices/enterprises and a network 109, and messages routed across network 109 are processed in system 107 in order to generate data that can be used to determined profile data and intelligence for a number/device/identity.

Some intelligence will be factual whereas other data of value is behaviour based, as the ability to predict a phone number's propensity to perform an action or respond positively for example. In an example, the acquisition of new data is performed without causing a caller any performance related issues. The ingestion of the data is asynchronous to allow buffering of incoming data prior to analysis and loading into the database. To gather suitable information, raw data is used rather than filtered or aggregated renditions of data for messages.

According to an example, a data generation process can operate in multiple ways. For example, one process can use an explicit push in which a target process pushes a set of information into the system 107 at an appropriate point. The data is pushed with minimum performance impact on the caller, and asynchronously as this mechanism is one way only. Alternatively, data scavenging can be performed in which the data in the database is processed in order to derive behaviour or facts. In general, the approach for providing data into system 107 is an additive one. That is, information that is provided is used, however if there are gaps in the information the current values remain in database 103.

Data Sources representing an identified phone number intelligence source can include:
SMS Aggregation Systems
SMSC Systems
URL Shortening Systems
OTT Messaging Systems

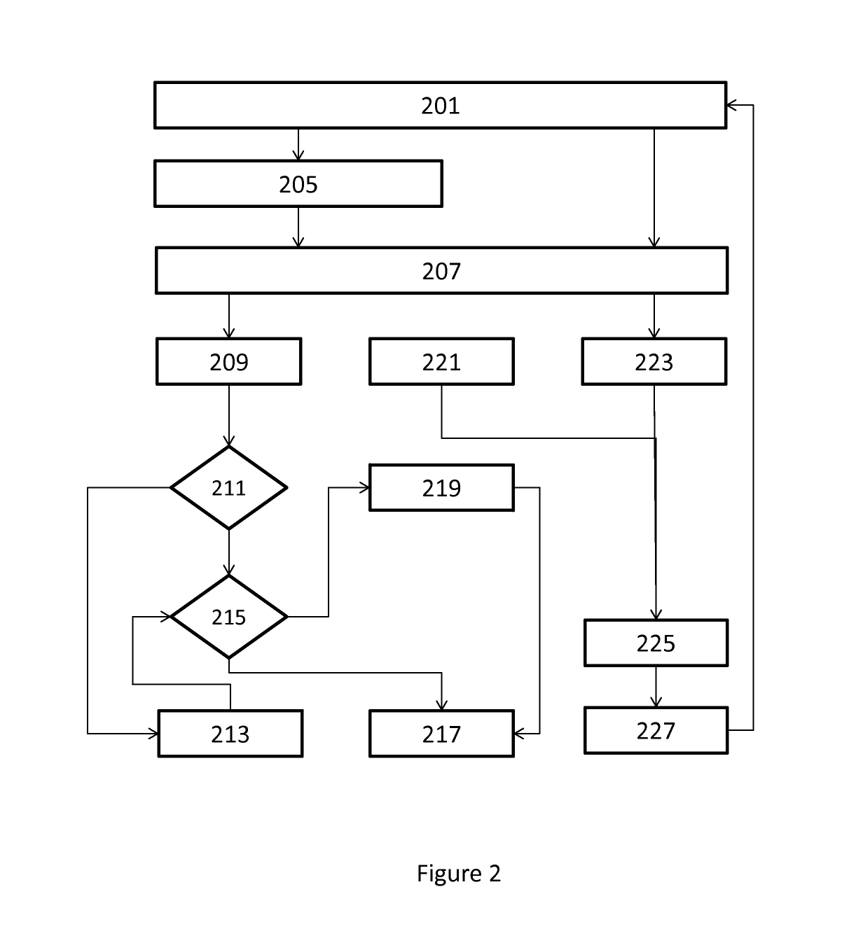

FIG. 2 is a flowchart of an overview of a messaging system according to an example. An external organisation 201 such as an enterprise for example is an entity that wants to send a message to multiple recipients. The message can be a marketing message for example, and can include text content, URLs, multimedia content and the like in any combination. In block 205, enterprise 201 uses an upload portal to provide a message or set of messages and data relating to one or more recipients for a system according to an example. A web-based or standalone application can be used to provide a gateway between enterprise 201 and the system of the present invention, and can include an interface (not shown) to allow an enterprise to easily upload data and make selections relating to desired recipients. Alternatively, enterprise 201 can bypass block 205 and provide data directly to an API 207 that links the enterprise with the system, such that data can be provided ‘as-is’ for example.

In block 209, a message is forwarded for sending. Prior to the message being sent using one of the mechanism described above, in block 211 it is determined if the message should have tracking applied. That is, if the message includes one or more URLs for example, these can be shortened and tracked in block 213. A URL can be shortened by using an HTTP redirect on a domain name that is short, which links to the web page that has a long URL, as is known.

In block 215 it is determined if IF should be applied. If not, the message is forwarded for delivery at block 217 to a delivery service as described above. If, at block 215, IF is to be applied an IF template is applied at block 219. The template can be a filter or multiple filters that are applied to a set of numbers in order to arrive at a target set of recipients from the initial set provided by the enterprise 201. Predefined filters can be provided, as well as predefined sets of filters that go to make up a template. Alternatively, a template tailored to the particular requirements of the enterprise can be generated using multiple filters, each of which can be altered to suit the particular requirement of the enterprise or user. A filter can range from that which selects only numbers that are known to be active, or active or receptive on particular messaging platform from an initial set for example, to filters that can select only number that have a propensity to click-through a URL in a message within a particular market sector in a given timeframe for example.

In an example, a set of numbers can be used to generate a query result that can be returned to the enterprise without a message being sent. That is, recourse can be made at blocks 221 and 223 to query tracking data and intelligence data of a database 225. In block 227 a charge can be made per look up operation for example and the results can be passed back to the enterprise at block 201. In this way, a template can be used, but rather than the filtered numbers being sent a message, they are returned as a query result to the customer.

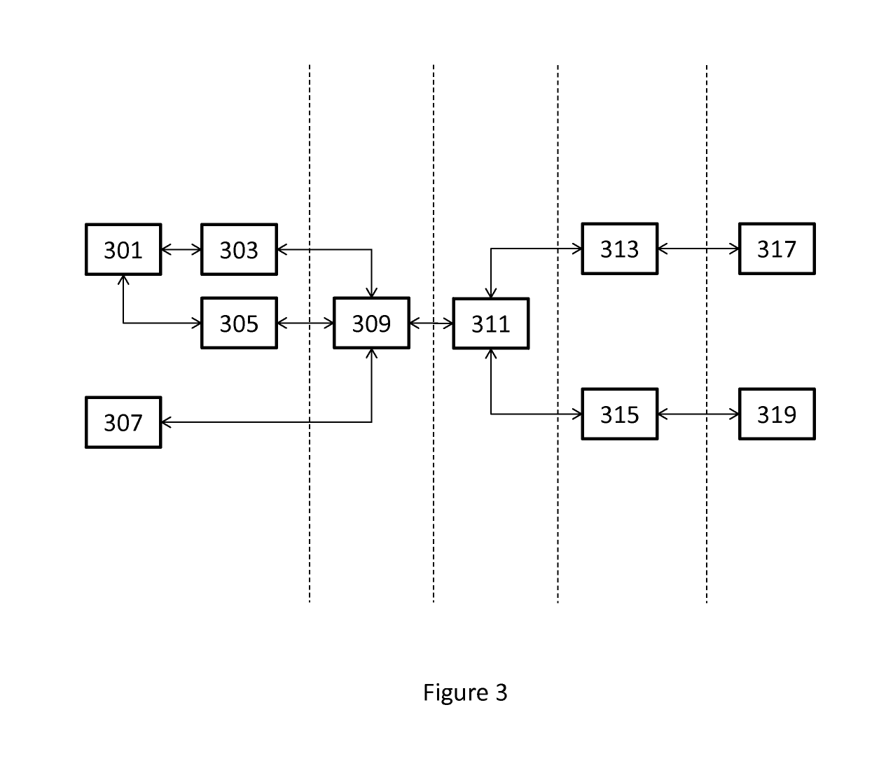

FIG. 3 is a schematic block diagram of an overview of a system according to an example. A user 301 can interact with the system via an enterprise product at block 303 or using a desktop application in block 305. For example, a plug-in can be provided that can enable a user 301 to leverage the system of the present invention from within an existing application. A web user 307 can also use the system, and all are connected to the internet in block 309. Accordingly, interactions can be made with a platform of the system in block 311. For example, a messaging campaign can be set up in which a target set of numbers to message is generated based on an initial set that has been filtered using a template as described above. Within the messaging platform a message can be forwarded for sending using multiple carriers. A message can be sent using XMPP (Extensible Messaging and Presence Protocol) for example in block 313 to recipients 317. Alternatively, a message can be sent in block 315 to recipients 319 using SMPP (Short Message Peer-to-Peer) for example. Other alternatives are possible as will be appreciated.

1. An information management system comprising:
an activity database to receive messaging data from multiple user equipment devices over at least one messaging channel of a network;
a profile engine to generate a profile for an identity using the messaging data, the identity associated with at least one of the devices.

2. A system as claimed in claim 1, wherein a messaging channel is an SMS channel of a telecommunication network and/or a messaging channel of an over-the-top peer-to-peer communication network.

3. A system as claimed in claim 1, wherein the identity is globally unique identity for the network.

4. A system as claimed in claim 3, wherein the identity is an internationalised format phone number.

5. A system as claimed in claim 1, wherein the profile engine is operable to generate a profile for an identity including multiple dimensions relating to network activity.

6. A system as claimed in claim 1, wherein the activity database is operable to:
receive messaging data representing a message to be forwarded over or that is received from the network;
process the messaging data to determine message content; and
parse the content to determine the presence of a URL.

7. A computer program product, comprising a computer usable medium having computer readable program code embodied therein, said computer readable program code adapted to be executed to implement a method for generating data relating to multiple recipients of a message by receiving messaging data from multiple user equipment devices over at least one messaging channel of a network at an activity database;
generating a profile for an identity using the messaging data at a profile engine, the identity associated with at least one of the devices.

8. A computer-implemented method to generate data relating to multiple recipients of a message, comprising:
monitoring the behaviour of a recipient of the message to determine multiple measures associated with receipt and consumption of the message and message content by the recipient at a device;
processing data representing the characteristics to provide profile data for a recipient;
providing a set of filters to form a query template for filtering the profile data to generate data for a recipient relating to multiple behavioural and factual characteristics.

9. A method as claimed in claim 8, further including:
determining the presence of one or more URLs in the message;
shortening or otherwise processing the URL to provide a modified link to data associated with the URL;
providing a correlation ID to directly correlate a click through event for the modified link;
using data associated with the event to determine one or more behavioural characteristics of the recipient.

10. A method as claimed in claim 8, wherein a behavioural characteristic represents a receipient's propensity to respond to or open the message, or follow the link after receipt of the message.
